(19) United States
(12) Patent Application Publication
(10) Pub. No.: US 2004/0059836 A1
(43) Pub. Date: Mar. 25, 2004

(54) Method for generating and displaying a digital datafile containing video data

(76) Inventor: Peter Spaepen, Geel (BE)

Correspondence Address: PATRICK REILLY, BOX 7218, SANTA CRUZ, CA, 95061-7218, US

(21) Appl. No.: 10/413,079

(22) Filed: Apr. 14, 2003

Related U.S. Application Data
(60) Provisional application No. 60/412,732, filed on Sep. 23, 2002.

(51) Int. Cl. G06F 15/16

(52) U.S. Cl. 709/247

(57) ABSTRACT

A method of generating a digital data file containing video data and presenting a visual image on a video monitor displaying the video data. A raw digital video file is expanded by increasing the bit size of the video data fields. The expanded digital video file may be modified using ADOBE AFTEREFFECTS video compositing software. The expanded digital video file may optionally be compressed using an intermediate HUVyuff codec function to generate a .WMV or an .AVI file conforming to an .AVI format. WINDOWS MEDIA ENCODER may be used to generate a .WMV file from the .AVI file. The resulting .WMV may then be viewed using either a standard WINDOWS MEDIA PLAYER software or a PLACEWARE software program.

### RELATED PATENT APPLICATION

This application claims benefit of the filing and priority date of Provisional Patent Application No. 60/412,732, filed on Sep. 23, 2002.

### FIELD OF THE INVENTION

The present invention relates to the systems and methods used convert and present a raw digital and analog video datafile via a computer network. More particularly, the present invention relates to improving techniques in delivering video content via the Internet or other suitable computer network.

### BACKGROUND OF THE INVENTION

The display of video data via computer networks, and particularly via the Internet, is an increasingly significant aspect of the consumer economy and the entertainment industries. The prior art teaches that a raw analog file or raw digital file is processed for Internet transmission by encoding the original electronic media file directly into a standard Internet transmission format. These prior art practices are effective in forming video files but deliver suboptimal performance in transmission efficiencies and viewer experience. The prior art typically requires that the digital data be formatted or encoded into one of several competing and incompatible video player formats, such as a REALPLAYER format or a WINDOWS MEDIA PLAYER format, or QuickTime for a compatible Apple computer.

Improvements in reducing bandwidth requirements, reducing the digital data file size, and enhancing the presentation experience of an Internet viewer are long sought after. The provision of a video datafile that can be viewed via MACROMEDIA's FLASH PLAYER software or another suitable image presentation software would expand the available market of most video presentations. The generation of a video datafile, optionally with combined and synchronized audio, that can be viewed via PLACEWARE software, or another suitable remote conferencing software, without little or no required modification affecting the base programmers framework, nor with significant interference with system administration—would expand the effectiveness of many Internet conferences using such software.

### SUMMARY OF THE INVENTION

In order to meet these objects, and other objects that are obvious in light this disclosure, a method of the present invention provides techniques to generate a data file containing a video information and transmitting the data file via a computer network to a viewing computer system.

In a first preferred embodiment of the method of the present invention, an electronic record containing video is converted into a raw digital file according to the dv (“DV”) format. The digital file is then substantially quadrupled in size by doubling the bit count of most value fields stored within the digital file and saved as an expanded data file. The .dv file may be processed through out the remaindering of the first preferred embodiment of the method of the present invention, or the .dv file may optionally and alternatively translated into a MJPG data file saved in the .MJPEG format.

In certain alternate preferred embodiments of the present invention, a DV file is encoded encode into a Windows Media file. or .WMV file, to obtain a superb image quality with a file size approximately between 25 and 50% of the file sizes generated by prior art techniques. Enhancing the presentation of a digital video file over an IP may provide the user with a better viewing experience with a bigger image dimension, i.e., normally a video file is transmitted/viewed over a broadband connection at a resolution of 320 pixels by 240 pixels. When encoding a video file with certain preferred embodiments of the present invention, the invented system can display an image size four times bigger then 640×480 pixel density.

Windows Media files are often transferred over an IP network using true streaming via the Microsoft Multimedia Server (“MMS”) protocol. This common application of MMS requires activity by a specific server. The method of the present invention optionally enables the transmission of a data or video file over a standard or regular HTTP protocol, and allows an intended or regular web server to stream the data or video files. The method of the present invention further optionally comprises the use “Progressive Download” or “Pseudo Streaming” protocols to transfer the resulting video file(s). This use of the HTTP protocol can result in an easier deployment, dissemination or broadcast of a video or data file via intended or regular web servers. In addition, the method of the present invention may be implemented to avoid firewall denials of transmission. Firewalls may be configured by system administrators to prevent misusage by employees or unauthorized users of an Intranet, Extranet or other communications network to block communications into a communications network that are not either (1) substantially or (2) completely HTTP compliant. The method of the present invention optionally enables streaming files over intended or regular HTTP networks without modification of a recipient system set up.

In the Windows Media environment certain alternate preferred embodiments of the method of the present invention may include a pre encoding in the MPEG 2 or the HUVyuff codec . This pre-encoding may ensure improved or optimum file preservation with an intermediate codec whereby the quality gets preserved but the file size reduced a considerable amount without substantially degrading the initial deliverable image quality. The method of the present invention optionally enables the use of intermediate codecs to take the huge file sizes out of uncompressed data or video file.

In certain still alternate preferred embodiments of the present invention the raw video data is maintained in a raw video format without prior encoding to .MJPEG for the sake of quality. Prior encoding to .MJPEG file may optionally or preferably applied in low motion video sessions, such as a “Talking Heads” presentation scenario, where a modest portion of the screen frame data varies from frame to frame. In other words, where a video file is made from a video record of session, and that session has little motion content, or content that is rather static, the option exists within the method of the present invention to optionally pre encode with a lower quality codec, and speed up all or part of the invented process, because a lower quality codec may generate a smaller intermediate file size.

The expanded data file, stored in the .dv format, the .mjpeg format, or other suitable data format known in the art, is then processed in a computer system running an ADOBE AFTER EFFECTS video data compositing software program, or another suitable video data compositing software program. A user of the computer system may then use the video data compositing software to modify one or more optional steps, to include: (1) color correction, cropping and resizing, gamma adjustment, and/or brightness adjustment. Gamma adjustment and brightness adjustment are typically done with an understanding of the operational characteristics of selected video hardware models and to modify the expanded data file to provide acceptable or optimized image quality on one or each of the selected video hardware models.

In certain preferred embodiments of the present invention, the ADOBE AFTER EFFECTS software is used in an inventive, non-obvious and novel way to improve the image quality made possible by the method of the present invention. AFTER EFFECTS has a color transparency function that allows the user to modify a digital date file to create a region of color within a displayed frame of the digital data file. This function is used in the prior art to create a background region within which to place text or other graphic content. The method of the present invention uses this AFTER EFFECTS color transparency function to innovatively improve the resultant image quality delivered by certain preferred embodiments of the present invention. In this optional technique, the user of the computer system selects a color that, when added to the visual presentation of the digital data file improves the image quality and viewing experience. The user then imposes this color in a region substantially or totally encompassing the frame produced by the digital data file. The user may set the image transparency in the range of within approximately 5% to approximately 7%. The user may impose this color transparency region substantially or completely throughout the entire digital file, or in one or more individual segments of the digital data file. The user may optionally impose more than one color region, individually or in combination, substantially or completely throughout the entire digital file, or in one or more individual segments of the digital data file. Noise incidence of the expanded digital data file may be reduced by this innovative and nonobvious method of using the color transparency addition capability of ADOBE AFTER EFFECTS (“AE”). Different transparent color layers can optionally be put on the .dv file once the dv file is imported into the AE. This optional and non-obvious use of color solids dramatically reduces noise build up in the output file. In the first preferred embodiment of the present invention, the expanded digital data file is compressed through a codec software program after modification by use of the video compositing software. In certain preferred embodiments of the present invention a CLEANER codec software program, or other suitable codec software program known in the art, is used to compress the expanded digital data file. The CLEANER software may optionally be used to compress the expanded digital data file into a compressed file formatted according to the .vp3 standard. The CLEANER software may be used to compress the expanded digital data file by the user in light of an anticipated data transmission rate and with an intent to more optimally generate a compressed data file that will by transmitted at the anticipated data transmission rate. The user may optionally and additionally select an anticipated pixel count and image dimensions of the video image generated from the compressed data file and may compress the expanded digital data file in light of more optimally producing an encoded data file that will be used to produce video images having the anticipated pixel count and image dimensions. The user may optionally use the CLEANER software program's blur function, preferably at a factor of approximately 0.03% in many cases, to modify the compressed data file to generate a slightly blurred image and thereby improve quality of the resulting displayed image. This blurring may reduce artifacts and noise of the ultimate resulting displayed image.

The previous step described as the After Effects process doesn't change when porting to the Windows Media environment - each and every step can be applied to a pre processed video file. The method of the present invention optionally and/or additionally enables a saving of the video or data file in the previous intermediate codec HUVyuff or MPEG 2. The HUVyuff may provide the best intermediate compression, and may be preferred to the MPEG 2 codec. MPEG 2 may suffice when the content of the video file is low motion.

In the first preferred embodiment the compressed data file may be encoded by applying CLEANER and from the .vp3 format and into a QuickTime file formatted in the .mov standard.

When applying the workflow for Windows Media the .VP3 format and the QuickTime architecture may optionally be changed to .WMV and the .AVI standard. It is understood that .WMV is the standard extension for a Windows Media file while .AVI. that .AVI stands for Audio Video Interleaved. The QuickTime file may be converted into to an .SWF file that is formatted according to the .swf data format standard, and by using SORENSON SQUEEZE transcoder or other suitable transcoder known in the art. QuickTime is no longer part of the workflow when Windows Media files are concerned all steps are done in .AVI and .WMV. In addition, when processing a Windows Media file, the Windows Media Encoder is used and the Sorenson Squeeze is not applied. Furthermore, it is preferable that that all of pre processing be done correctly prior to employing the Windows Media Encoder (“WME”) and to provide the WME with a well or optimally pre processed top shape video file in the form of an .AVI with (preferably) an HUVyuff as intermediate codec.

It is preferable to convert the QuickTime file into the SWF file in accordance with the .vp3 codec standard, but the SORENSEN SQUEEZE transcoder employs an H263 codec software program. In certain alternate preferred embodiments of the present invention a transcoder is used to convert the QuickTime file into the SWF file in accordance with the .vp3 codec standard

One or more audio channel data files, and preferably two audio channel data files are independently converted and/or transcoded into an .mp3 audio digital data files conforming to the MP3 data format standard.

When working towards a Windows Media end result the method of the present invention may optionally not apply the .MP3 format for audio encoding, as WME has its own very good audio codec Windows Media Audio 9. This Windows Media Audio 9 format is readable through WMA 9-decoder standard available in the Windows Media player.

The WMA codec may give a better compression ratio then MP3 and is therefore often a better choice than the MP3 method. Because of the simultaneous throughput of both the video and the audio file through the WME, a single operation to get a top quality encode with synchronized video and audio may be achieved. Where a combined video and audio file may be read and played back using the standard Windows Media player, no additional downloads or installs may not be necessary.

Alternatively, where the method of the present invention employs the MP3 method, an .mp3 file may be then combined with the SwF file and transmitted to a client computer system over the Internet. The client computer system may then be directed by a viewer to use a MACROMEDIA FLASH PLAYER software program, or other suitable video data presentation software known in the art, to generate a visual and optional audio presentation from the SWF file via a video display and audio output modules of the client computing system.

Alternatively, the viewer may direct the client computer system to use PLACEWARE software program, or other suitable video conferencing software known in the art, to generate a visual and optional audio presentation from the SWF file via a video display and audio output modules of the client computing system. In addition, this encoding set up the output may optionally be optimized to play back in a third party web collaboration environment such as PlaceWare or WebEx—without interference of a system administrator or additional downloads or installs. When using a web collaboration tool such as PlaceWare and/or WebEx it is possible in certain preferred embodiment of the method of the present invention to enhance the video/audio experience with built-in URL's pointing to (1) GIFS, (2) JPEGS, (3) text tickers, (4) synchronized Flash animations, (5) and/or on or offline webpages to provide a rich media result that may optionally or possibly be delivered through firewalls.

The certain preferred embodiments of the method of the present invention comprise the automation of certain steps of the manual process. Automating software filters may be written, coded and used to fully or partially enable an operator to automate or execute by automation one or more than one of the manual steps of the preferred embodiments described herein.

In certain yet alternate preferred embodiments of the method of the present invention the one or more steps of the workflow of the present invention may be automated, scripted and/or coded.

Other aspects of the present invention include an apparatus and a computer-readable medium configured to carry out the foregoing steps.

The foregoing and other objects, features and advantages will be apparent from the following description of the second design of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which:

FIG. 1 is an illustration of a computer network used to implement a preferred embodiment of the present invention.

FIG. 2 illustrates the partial workflow of a first preferred embodiment of the present invention.

FIG. 3 illustrates the partial workflow of a first preferred embodiment of the present invention complementary to the partial workflow of FIG. 2.

FIG. 4 illustrates the partial workflow of a second preferred embodiment of the present invention operating within a Windows Media environment.

FIG. 5 illustrates a partial workflow of the second preferred embodiment of the present invention complementary to the partial workflow of FIG. 4.

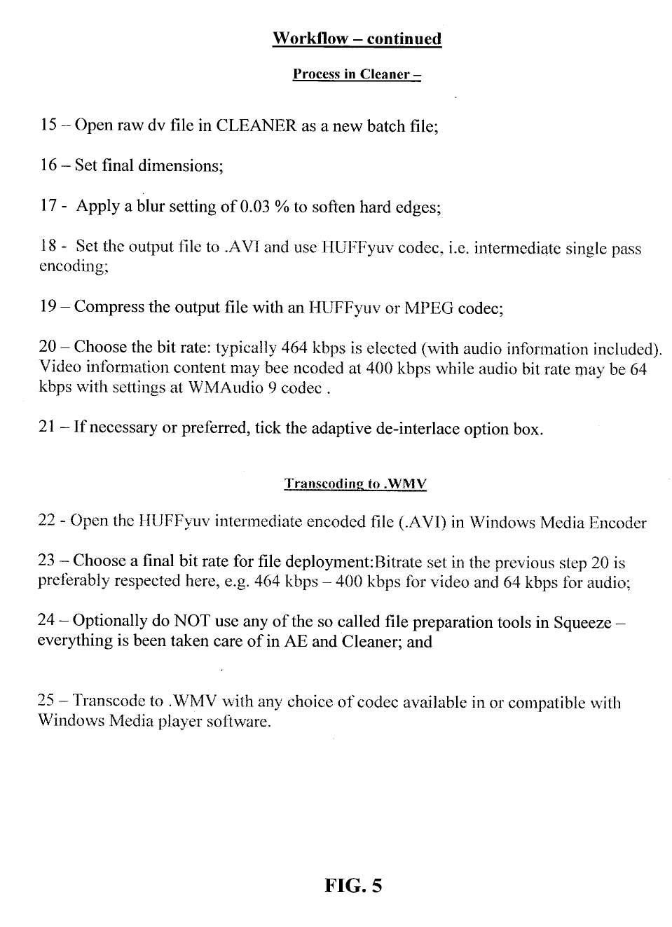

FIG. 6 illustrates a partial workflow of the second preferred embodiment of the present invention complementary to the partial workflow of FIG. 5.

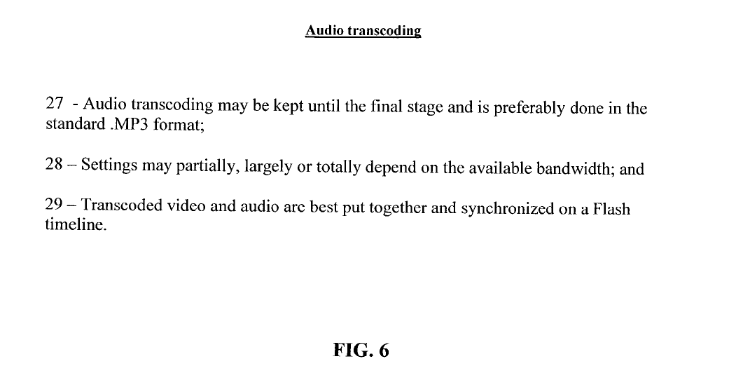

### DETAILED DESCRIPTION OF PREFERRED EMBODIMENTS

In describing the preferred embodiments, certain terminology will be utilized for the sake of clarity. Such terminology is intended to encompass the recited embodiment, as well as all technical equivalents which operate in a similar manner for a similar purpose to achieve a similar result.

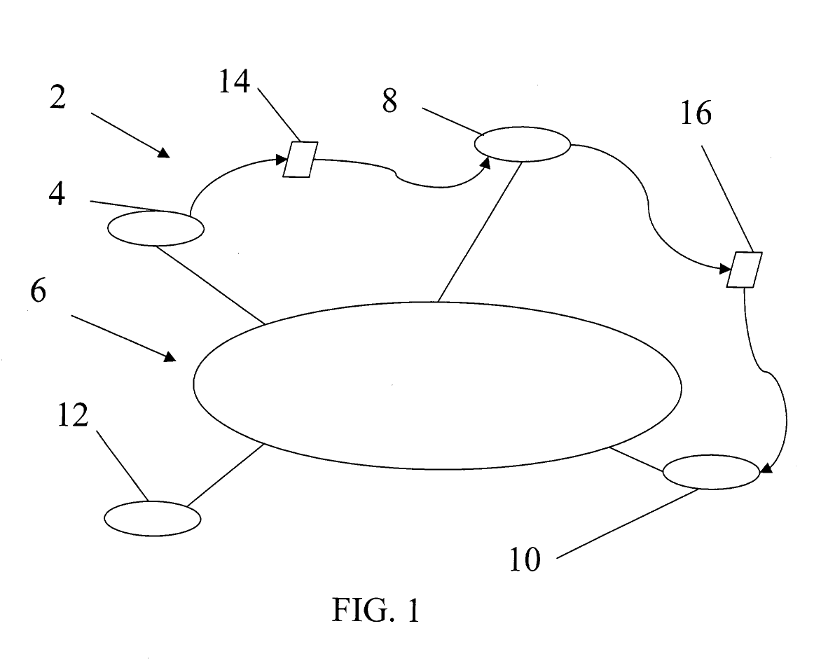

Referring now generally to the Figures, and particularly to FIG. 1, a computer network 2 comprises a video file generator 4, a communications network 6, a video processing workstation 8, a server computer 10, a client computer 12, and a computer-readable medium 14. The computer network 2 or the communications network 6 may be or comprise the Internet or another suitable communications network. The video file generator may alternatively or optionally include a digital camera that observes and digitizes a visible image or scene or forms a digitized and stored representation of the observed image or scene in a video file 16. The video file 16 is then copied or transferred to the computer-readable medium 14. The computer-readable medium 14 provides the video file to the video processing work station 8. Alternatively or additionally, the video file may be provided to the work station 8 via the transmission through the communications network 6. It is understood that the video processing work station 8, or computer system 8, may comprise one or a plurality of computers, where each computer system is capable of performing, and equipped with adequate and suitable software to perform, one or more steps, process or subprocess of a preferred embodiment of the method of the present inventions, to optionally and not exclusively include the functions of editing the video file, enlarging the video file, clipping the video file, data compressing the video file, cropping and resizing the dimensions of the video file, encoding the video file, transmitting the video file, transcoding and other suitable functions known in the art.

The video processing workstation 8 may comprise one or more of the software programs, utilities or files discussed below, and/or other suitable software programs known in the art, and for the purpose of at least partially implemented a preferred embodiment of the method of the present invention.

The term “computer-readable medium” as used herein refers to any medium that participates in providing instructions to the network 2 or to a computational such as the video file generator 4, the communications network 6, the video processing workstation 8, the server computer 10, and/or the client computer 12, for execution. Such a medium may take many forms, including but not limited to, non-volatile media, volatile media, and transmission media. Non-volatile media includes, for example, optical or magnetic disks, such as storage device 23. Volatile media includes dynamic memory. Transmission media includes coaxial cables, copper wire and fiber optics. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to the network 2 for execution. For example, the instructions may initially be carried on a magnetic disk of a remote computer. The remote computer can load the instructions into its dynamic memory and send the instructions over a telephone line using a modern. A modern local to or communicatively linked with the network 2 can receive the data on the telephone line and use an infra-red transmitter to convert the data to an infra-red signal. An infra-red detector can receive the data carried in the infra-red signal and appropriate circuitry can provide the data to the network 2.

Alternatively or additionally, the processed video file may be provided to the server 8 via the transmission through the communications network 6.

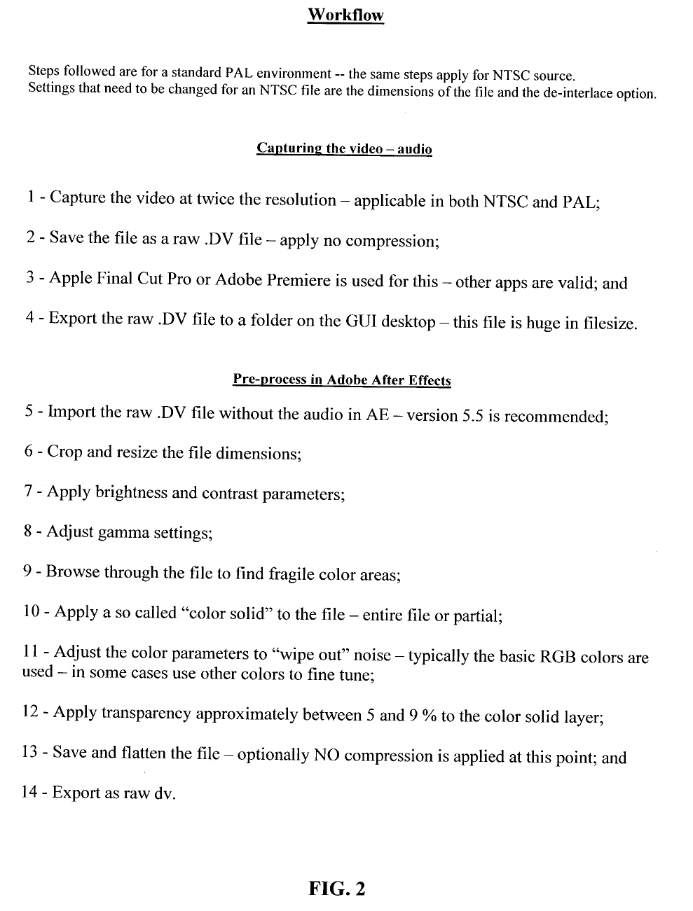

Referring now generally to the Figures and particularly to FIGS. 1 and 2, a computer system 8 is provided that allows an operator to run and use APPLE FINAL CUT PRO, ADOBE PREMIERE, AFTER EFFECTS, CLEANER and SQUEEZE, or other suitable and partial or whole functional equivalents known in the art. The operator places a first datafile containing video information and captures the video at twice the resolution—applicable in both NTSC and PAL. The operator may save the file as a raw .DV file and apply no compression. APPLE FINAL CUT PRO, ADOBE PREMIERE or other suitable functional equivalents known in the art. The operator than exports the raw .DV file to a folder on the computer system's graphical user interface or desktop. This .DV file may be huge in file size in comparison to the first datafile.

The operator next imports the raw .DV file without the audio in AE. NOTE: AE version 5.5 is recommended for use at this point. The operator may then crop and resize the file dimensions. The operator may then apply brightness and contrast parameters. The operator may then adjust gamma settings. The operator may then browse through the file to find fragile color areas. The operator may then apply a “color solid” to the file—as an entire file or a partial file. The operator may then adjust the color parameters to “wipe out” noise - typically the basic RGB colors are used and in some cases use other colors to fine tune the coloring of the resultant image. The operator may then apply transparency between 5 and 9% to the color solid layer. The operator may then save and flatten the file—optionally NO compression is applied at this point. The operator may than export as a second datafile as raw dv.

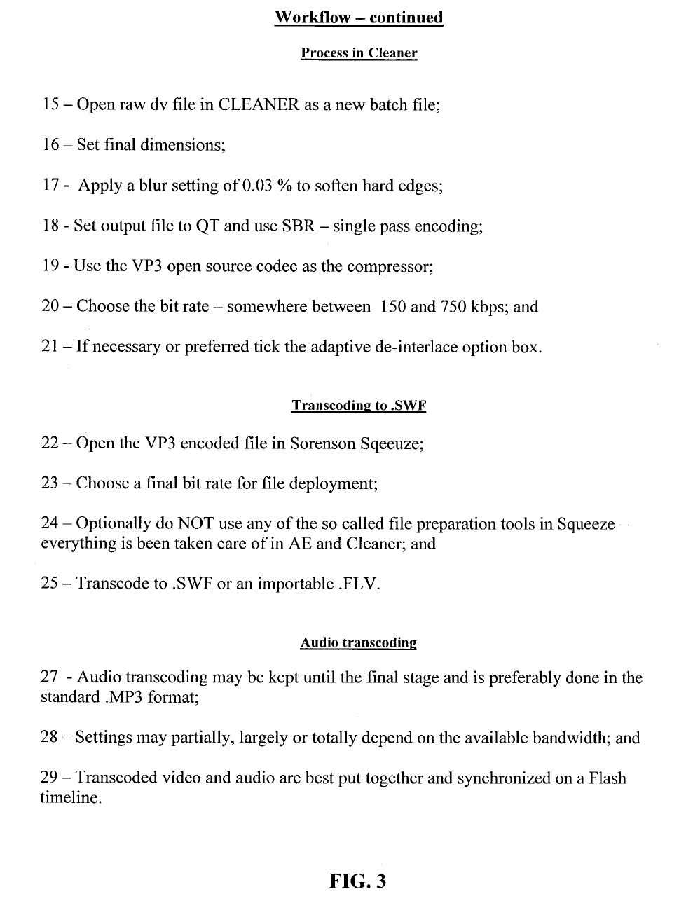

Referring now generally to the Figures and particularly to FIGS. 1, 2 and 3, the operator may then open the second datafile in CLEANER as a new batch file. The operator may set the final dimensions of the second datafile as it will be output from CLEANER as a third datafile. The operator may apply a blur setting of 0.03% to soften hard edges. The operator may set the output file, or third datafile, to QT and use SBR in single pass encoding. The operator may use the VP3 open source codec as a data compressor. The operator may choose the bit rate of the third datafile- somewhere between 150 and 750 Kilo-Bits per Second (“kbps”). The operator may optionally tick the adaptive de-interlace option box. The third datafile is then output or exported as a VP3 encoded file.

The operator may open the VP3 encoded third datafile in SQUEEZE. The operator may choose a final bit rate for file deployment. The operator may optionally not use any of the file preparation tools in SQUEEZE. The operator may transcode the third datafile to .SWF or an importable .FLV to form a fourth datafile.

Audio transcoding may be kept until the final stage and may be done in the standard .MP3 format. The settings of the audio file may be dependent on the available bandwidth. A transcoded video and audio file may best put together and synchronized on a Flash timeline to form a final datafile.

The final datafile may then be played on a suitable revision of FLASH PLAYER, a suitable revision of PLACEWARE, or another suitable video file player known in the art. The final data file may then be transferred to or copied from the computer system 8 and to the server 10 by means of a computer-readable medium 16 and/or transmission via the communications network 6. A consumer may then use the client computer 12 to access the final data file via the computer network 2 or the communications network 6 and run or execute a video presentation with a FLASH PLAYER video presentation software, the video presentation software being at least partly resident upon the client computer 12.

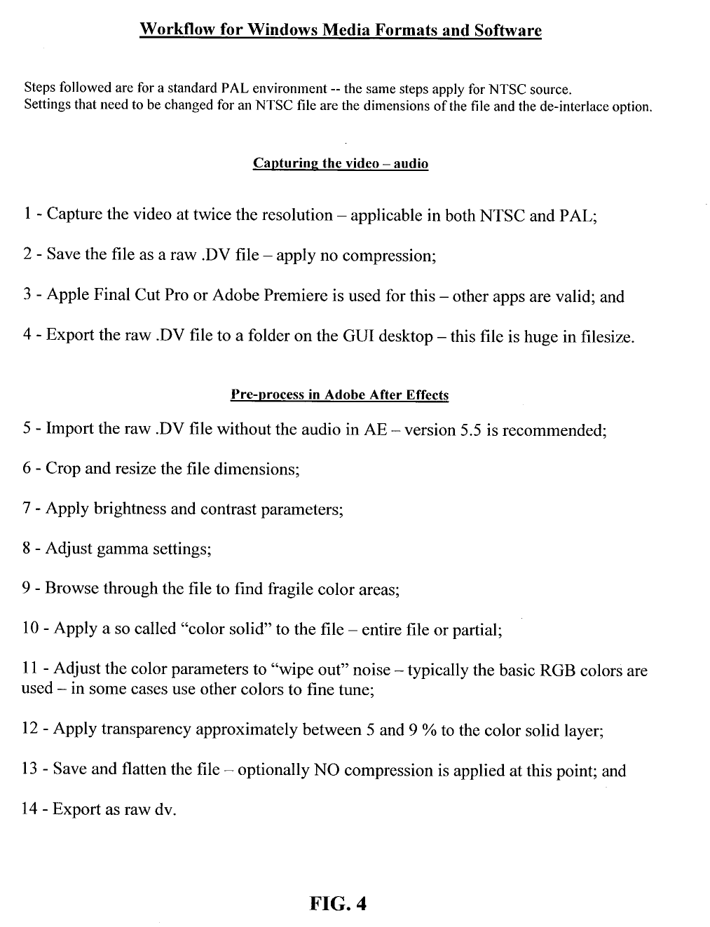

Referring now generally to the Figures and particularly to FIGS. 1, 4,5 and 6, the computer system 8 is provided that allows an operator to implement a second preferred embodiment of the method of the present invention. The second preferred embodiment of the present invention is performed in compliance with, or in consideration of MICROSOFT WINDOWS operating systems formats, and other suitable information processing formats or standards. Certain processes steps followed within the second preferred embodiment of the method of the present invention are applicable for a standard PAL environment, and may apply for an NTSC source. Settings that may need to be changed for an NTSC file may include the dimensions of the file and the de-interlace option. The second preferred embodiment of the present invention substantively conforms to the following workflow:

1—Capture the video in a video file at twice the resolution—applicable in both NTSC and PAL;

2—Save the video file as a raw DV file—apply no compression;

3—Apple Final Cut Pro or Adobe Premiere is used for the compression of step 2—other suitable applications software known in the art are valid;

4—Export the raw DV file to a folder on the GUI desktop—this file may present a large memory filesize;

5.—Import the raw DV file without the audio in Adobe After Effects (“AE”)—version 5.5 is recommended;

6—Crop and resize the video data file dimensions;

7—Apply brightness and contrast parameters of the video data file;

8—Adjust gamma settings of the video data file;

9—Browse through the file to find fragile color areas of the video data file;

10—Apply a so called “color solid” to the file—optionally the entire video data file or partial section(s) of the video data file;

11—Adjust the color parameters to “wipe out” noise within the video data file(Note: typically the basic RGB colors are used—in some cases use other colors to fine tune);

12—Apply transparency approximately between 5 and 9% to the color solid layer of the video data file;

13—Save and flatten the video data file (Note: optionally NO compression is applied at this point); and

14—Export the video data file as raw dv;

15—Open raw dv file in CLEANER as a new batch file;

16—Set final dimensions of the video data file;

17—Apply a blur setting of 0.03% to soften hard edges of the video data file;

18—Set the output video data file to .AVI and use HUFFyuv codec, i.e. intermediate single pass encoding;

19—Compress the output file with an HUFFyuv or MPEG codec;

20—Choose the bit rate: typically 464 kbps is elected (with audio information included). Video information content may be encoded at 400 kbps while audio bit rate may be 64 kbps with settings at WMAudio 9 codec;

21—If necessary or preferred, tick the adaptive de-interlace option box;

22—Open the HUFFyuv intermediate encoded file (.AVI) in Windows Media Encoder;

23—Choose a final bit rate for file deployment: Bitrate set in the previous step 20 is preferably respected here, e.g. 464 kbps-400 kbps for video and 64 kbps for audio;

24—Optionally do NOT use any of the file preparation tools in SQUEEZE; and

25—Transcode to .WMV with any choice of codec available in or compatible with Windows Media player software.

27—Audio transcoding may be kept until the final stage and is preferably done in the standard .MP3 format;

28—Settings may partially, largely or totally depend on the available bandwidth; and

29—Transcoded video and audio are best put together and synchronized on a Flash timeline.

Separate audio encoding is typically not needed in the Windows Media Player workflow of certain preferred embodiments of the method of the present invention. One exception to this guideline may occur when encoding audio information content in 5.1 Dolby Surround Sound, where the sound artifacts may be produced in the resulting file due to a known bug in how the Windows Media encoder synchronizes the video and audio in the resulting .WMV file.

The final .WMV file may then be transferred from the computer system 8 and to the server 10 via the computer-readable medium 16 and/or via the communications network 6, and the communications network 6. A consumer may then use the client computer 12 to access the .WMV file via the computer network 2 or the communications network 6 and run or execute a video presentation with a WINDOWS MEDIA video presentation software, or a compatible video presentation software, the video presentation software being at least partly resident upon the client computer 12.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

I claim:

1. In a computer system, a method for generating a video file for transmission via a computer network, the method comprising:
providing an electronic data file containing video information; and
converting the electronic data file into the digital video file; and
substantially increasing the size of each data value of the digital video file.

2. The method of claim 1, the method further comprising
providing the computer system with a video compositing software program; and
employing the video compositing software program to modify the digital video file.

3. The method of claim 2, the method further comprising:
providing a computer system with a video compression software package; and
generating a compressed digital video file by compressing the digital video file with the video compression software package.

4. The method of claim 3, the method further comprising:
providing a computer system with a video data file encoding software program, the video data file encoding software program for encoding a digital video file into an encoded digital data file for transmission over a computer network; and
encoding the digital video file with the video data file encoding software program and generating a first encoded digital data file.

5. The method of claim 4, the method further comprising:
providing a client computing system with a client video software program, the client video software program for enabling the client computing system to visually display an encoded digital data file via a video display of the client computing system;
placing the client computing system into electronic communications with the computer network; and
transmitting the first encoded digital data file to the client computing system via the computer network.

6. The method of claim 5, the method further comprising:
decoding of the first encoded digital data file by the client video software program; and
displaying the decoded first encoded digital data file to a viewer via the video display device of the client computing system.

7. The method of claim 6, wherein the client video software program is image presentation software.

8. The method of claim 1, wherein the video image file is a .DV file.

9. The method of claim 2, further comprising:
import the digital video file into the video compositing software program;
crop and resize the file dimensions of the digital video file;
apply brightness and contrast parameters to the digital video file;
adjust gamma settings of the digital video file;
browse through the digital video file to find fragile color areas of the digital video file;
apply a color solid to the digital video file;
adjust the color parameters of the digital video file to reduce noise components of the digital video file;
apply transparency to the digital video file of approximately between 5 and 9% to the color solid layer of the digital video file; and
save and flatten the digital video file.

10. The method of claim 3, wherein the video compression software package is a VP3 open source codec.

11. The method of claim 3, the method further comprising setting the bitrate of the transmission of the encoded digital data file approximately within the range of 150 and 750 kbps.

12. The method of claim 10, the method further comprising setting the bitrate of the transmission of the encoded digital data file approximately within the range of 150 and 750 kbps.

13. The method of claim 3, wherein the video compression software package is selected from the group consisting of an HUFFyuv and MPEG software compression program.

14. The method of claim 3, the method further comprising setting the bitrate of the transmission of the encoded digital data file approximately within the range of 150 and 750 kbps.

15. The method of claim 13, the method further comprising setting the bitrate of the transmission of the encoded digital data file approximately at 464 kbps.

16. The method of claim 15, the method further comprising setting the bitrate of the transmission of the encoded digital data file approximately at 464 kbps.

17. The method of claim 16, wherein video information content of the encoded digital file is encoded approximately at 400 kbps.

18. The method of claim 17, wherein audio information content of the encoded digital file is encoded approximately at 64 kbps.

19. The method of claim 3, wherein the method further comprises transcoding the the encoded digital file into an .FLV compatible data file.

20. The method of claim 3, wherein the method further comprises transcoding the the encoded digital file into a .SWF compatible data file.

21. The method of claim 3, wherein the method further comprises transcoding the encoded digital file into an .WMV compatible data file.

22. A computer-readable medium carrying one or more sequences of one or more instructions for buffering data, wherein the execution of the one or more sequences of the one or more instructions by one or more processors, causes the one or more processors to perform the steps of:
providing a computer system, linked with a computer network;
generating a video file for transmission via the computer network;
providing an electronic data file containing video information; and
converting the electronic data file into the digital video file; and
substantially increasing the size of each data value of the digital video file.
